(19) United States
(12) Patent Application Publication
(10) Pub. No.: US 2007/0098954 A1
(43) Pub. Date: May 3, 2007

(54) Plastic/metal hybrid engine shield

(76) Inventor: Richard J. Kozerski, Lisle, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/264,640

(22) Filed: Nov. 1, 2005

(51) Int. Cl. B32B 3/04

(52) U.S. Cl. 428/124

(57) ABSTRACT

An embodiment of a heat shield provides a sheet metal layer selectively facing a heat source and a plastic layer coupled to the sheet metal layer. The heat shield further includes an insulation layer at least partially interposed between the sheet metal layer and the plastic layer.

### TECHNICAL FIELD

The technical field relates to protective heat shields for vehicular engine parts, such as engine exhaust manifolds that transmit substantial heat and vibration during engine operation. More specifically, the technical field relates to fabrication of protective heat shields and novel application of structures that may reduce weight and costs and increase the dampening of such heat shields.

### BACKGROUND

The exhaust manifolds of internal combustion engines in today's modern vehicles can reach under-the-hood temperatures exceeding 1600 degrees Fahrenheit. Such high temperatures create significant risks of damage to electronic components sharing under-the-hood space with the manifolds. Thus, protection has been provided for such components via use of heat shields designed to at least partially cover up and insulate exhaust manifolds and other heat generating components. In some cases, the shields have been effective to reduce measured temperature levels to within a range of 300 degrees Fahrenheit.

A typical multilayer heat shield positioned adjacent a component such as an exhaust manifold uses spaced layers of metal with air gaps between the layers. These typical heat shields transmit heat along the layer directly adjacent the component while the next adjacent layer is insulated from this heat by the air gap. Since the metal layers are free to vibrate, they typically respond to resonate frequencies, or frequencies that are transmitted through contact, and transmit undesired noise. Other multilayer heat shields use metal layers with insulation interposed between the layers. Unlike heat shields without insulation, the insulation dampens the vibrations of the metal layers at locations of contact. Typically, a normal, inward force is provided between the metal layers to ensure increased contact between the insulation and metal layers in order to dampen the vibrations in the metal layers.

The outer metal layer is typically formed of aluminized sheet steel. In order to increase the effectiveness of the shields and reduce the space required for the shields, the metal layers are typically contoured to closely resemble the shape of the outer surface of the exhaust manifold. To provide the desired contour in sheet steel, a generally planar piece of steel is stamped or formed in a progressive die. The resulting outer metal layer of a heat shield typically includes a number of wrinkles. These wrinkles reduce the aesthetic appearance of the heat shields, thin any anti-corrosion coating that may be applied, provide thinned brittle stress regions for future areas of cracking and other failures, and decrease the natural frequency of the heat shield in the region of the wrinkle which may excite frequencies in other regions of higher natural frequency in the heat shield and increase noise transmission. The outer metal layer of a typical heat shield also increases weight and cost.

FIG. 1 illustrates an engine 20. Engine 20 includes a cylinder head 24, an exhaust manifold 26, and a prior art heat shield 30. The heat shield 30 is adapted to closely surround at least portions of the exhaust manifold 26. The exhaust manifold 26 is bolted via bolts (not shown) to a plurality of engine exhaust ports 40 on the flank or side 42, of the cylinder head 24.

The exhaust manifold 26 includes cooperating ports (not numbered) in fluid communication with exhaust ports 40. The exhaust manifold 26 also includes mounting bosses 50 for attachment of the heat shield 30 to the exhaust manifold 26 via bolts 52. The engine exhaust ports 40 operate to collectively receive exhaust gases from individual combustion chambers (not shown) of the engine 20, and to funnel those exhaust gases into a common exhaust pipe portion (not shown) of the exhaust manifold 26.

The prior art heat shield 30 includes a contoured outer surface 62 that is formed from a layer of sheet steel to closely contour the outer surface of the exhaust manifold. Outer surface 62 includes wrinkles 64 resulting from the forming operation that produces the prior art heat shield 30.

While prior art heat shields perform adequately for their intended purposes, heat shields are an area of constant innovation to provide lighter, quieter, less expensive, and more aesthetically pleasing components.

### SUMMARY

An embodiment of a heat shield provides a sheet metal layer selectively facing a heat source and a plastic layer coupled to the sheet metal layer. The heat shield further includes an insulation layer at least partially interposed between the sheet metal layer and the plastic layer.

In a further embodiment, a heat shield includes an outer plastic layer having a first outer surface, a second outer surface, and an outer edge, and an inner metal layer defined, at least in part, by a first inner surface, a second inner surface, and a peripheral edge. The inner metal layer is selectively positioned directly proximal to a shielded component. At least portions of the first outer surface and the second inner surface define a gap therebetween.

In another embodiment, a method of manufacturing a heat shield includes the steps of forming an outer plastic layer, forming an inner metallic layer, and positioning the outer layer adjacent the inner layer.

### BRIEF DESCRIPTION OF THE DRAWINGS

FIG. 1 is a partial side elevation view of an engine having a prior art heat shield.

FIG. 2 is a partial side elevation view of a portion of an engine illustrating an embodiment of a heat shield.

FIG. 3 is a partial sectional view of the heat shield of FIG. 2 taken along fragmented line 3-3 of FIG. 2.

FIG. 4 is an enlarged partial fragmentary view of the heat shield of FIG. 2 taken along line 4-4 of FIG. 2.

### DETAILED DESCRIPTION

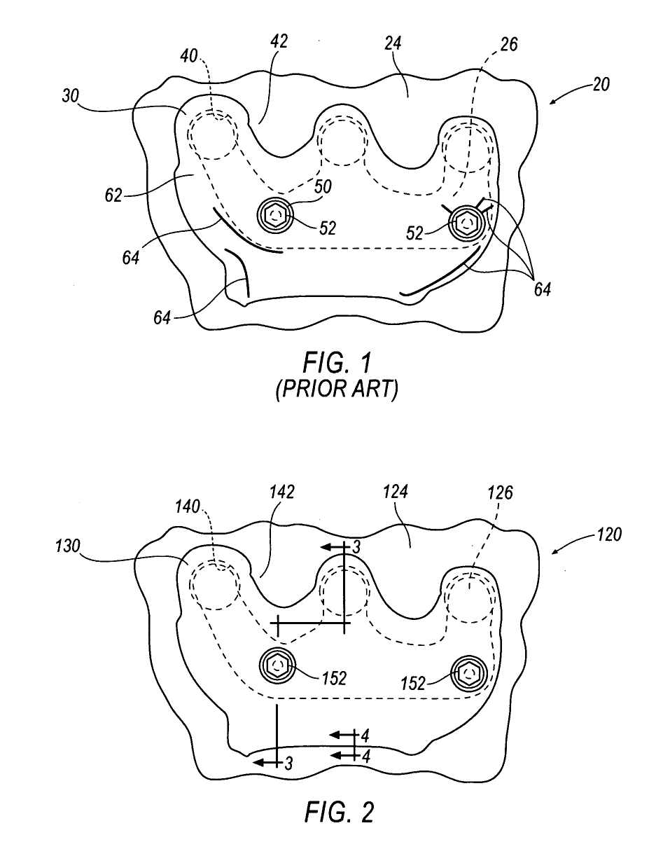

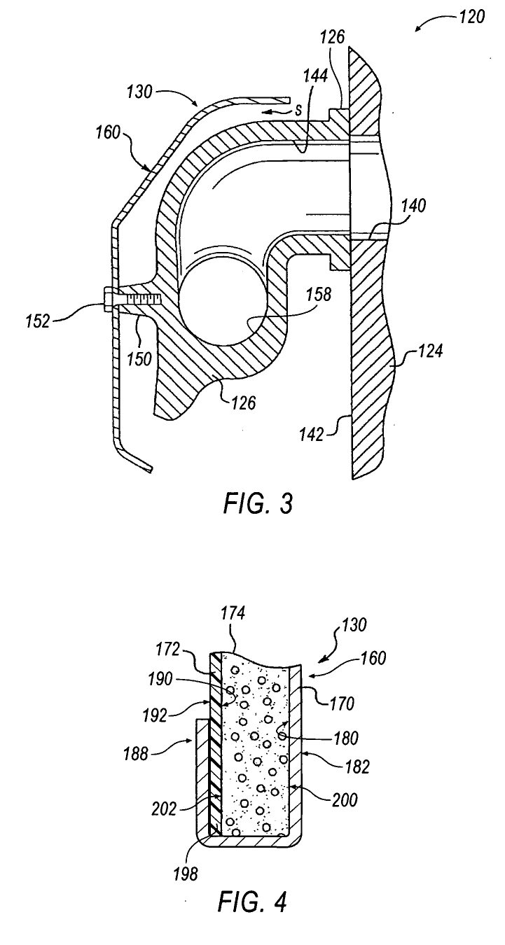

FIGS. 2 and 3 illustrate a portion of an engine 120. Engine 120 includes a cylinder head 124, an exhaust manifold 126, and a heat shield 130. The heat shield 130 is adapted to surround at least portions of the exhaust manifold 126. The exhaust manifold 126 is operatively secured via fasteners (not shown) to a plurality of engine exhaust ports 140 on the flank or side 142, of the cylinder head 124. Such fasteners may include bolts or other suitable fasteners known in the art.

The exhaust manifold 126 includes cooperating ports 144 (FIG. 3) in fluid communication with exhaust ports 140. The exhaust manifold 126 may also include mounting bosses 150 for attachment of the heat shield 130 to the exhaust manifold 126 via fasteners 152. The engine exhaust ports 140 operate to collectively receive exhaust gases from individual combustion chambers (not shown) of the engine 120, and to funnel those exhaust gases into a common exhaust pipe portion 158 (FIG. 3) of the exhaust manifold 126.

As best seen in FIGS. 3 and 4, the heat shield 130 includes a contoured body 160. The contoured body 160 dampens the structure of heat shield 130, thereby permitting heat shield 130 to attenuate vibrations, as described in greater detail below.

In FIG. 4, a partial cross-section of heat shield 130 is illustrated. Heat shield 130 is made up of a plurality of layers, such as an inner metal layer 170, and an outer layer 172, with an insulation layer 174 interposed therebetween. Inner metal layer 170 includes a first inner surface 180 that faces insulation layer 174, a second inner surface 182, and a peripheral edge 188. Outer layer 172 includes a first outer surface 190 that faces insulation layer 174, a second outer surface 192, and an outer edge 198. Insulation layer 174 includes an inner surface 200 that faces inner metal layer 170 and an outer surface 202 that faces outer layer 172.

At least a portion of peripheral edge 188 of inner metal layer 172 is folded over outer edge 198 of outer layer 170. In one embodiment, a sufficient amount of peripheral edge 188 is folded over, or overlays, outer edge 198 to retain insulation 174 therein and to couple layers 170, 172.

While heat shield 130 is illustrated in FIG. 4 as having an insulation layer 174 interposed in a gap between layers 170, 172, layers 170, 172 may be provided with no insulation layer 174 or a partial insulation layer 174. Additionally, insulation layer 174 may be at least partially absent and the gap remain between portions of layers 170, 172. Also contemplated is an embodiment of heat shield 130 where first inner surface 180 contacts portions of first outer surface 190.

In one embodiment, outer layer 172 is a layer of plastic material that retains insulation layer 174 in position and protects insulation layer 174 from environmental degradation. Outer layer 172 may be injection molded in a mold that produces an aesthetically pleasing second outer surface 192, or may be shaped from a piece of plastic material to form a desired shape.

As best seen in comparing FIGS. 1 and 2, the formation of outer layer 172 as a plastic component allows for an aesthetically curved second outer surface 192 such that surface wrinkles 64 of the prior art heat shield 30 are less pronounced or nonexistant. Also, an embodiment of outer layer 172 formed of plastic will reduce the vibrations transmitted from engine 120 as plastic will generally dampen vibrations when compared to a metal layer.

During operation of heat shield 130, inner metal layer 170 is generally at a greater temperature than outer layer 172. Therefore, inner metal layer 170 will expand more than outer layer 172. The differential expansion of layers will create a small normal force inwardly interacting between the inner metal layer 170 and the outer layer 172. The thicknesses and coefficients of thermal expansion of layers 170, 172 can effect the generally normal force between these layers.

Although described with three layers, the heat shield 130 could be effectively manufactured with additional layers, or with insulation layer 174 applied in selective regions of heat shield 130. The inner metal layer 170 would provide the requisite stiffness and support in such cases, but may need to be relatively thicker in some applications. While heat shield 130 is depicted as a heat shield for an exhaust manifold, heat shield 130 may be formed in various desired shapes and other components may be shielded.

The material choices for the thermally insulating and vibration and noise dampening insulation layer 174 are fairly broad. Such choices may include non-metallic fibers such as aramid fibers, or ceramic fiber paper. Depending on anticipated temperature ranges, even non-fiber compositions may be employed, such as densified vermiculite powders, for example.

The inner metal layer 170 is the portion of the heat shield 130 in closest proximity to the exhaust manifold 126. To the extent that the temperatures of the manifold can reach 1600 degrees Fahrenheit, the material of the inner metal layer 170 should be able to withstand significant heat. In some applications the inner metal layer 170 may be relatively shiny, formed of high-temperature alloys, and adapted to reflect heat back to the shielded component. In others, the inner metal layer 170 can be of less expensive materials including aluminum-clad steel. Inner metal layer 170 may also have wrinkles similar to wrinkles 64. Those skilled in the art will appreciate that choice of materials may be critical for avoiding degradation associated with elevated temperatures and for handling considerable vibrations in particular applications.

In one embodiment, inner metal layer 170 is aluminumized steel with a thickness between the first inner surface 180 and the second inner surface 182 of about 0.010 to about 0.030 inch. Even more preferably, inner metal layer 170 is aluminumized steel with a thickness between the first inner surface 180 and the second inner surface 182 of about 0.016 to about 0.020 inch. In the embodiment illustrated, inner metal layer 170 provides a significant amount of the structural support of the heat shield 130, although outer layer 172 may be formed of a material that provides structural support to the body 160 of heat shield 130.

One exemplary method of manufacturing of the heat shield 130 can be described as follows. The inner metal layer 170 and the outer layer 172 are preferably formed in separate operations. The inner metal layer 170 is positioned within a progressive die (not shown). The inner metal layer 170 is then stamped and formed in the progressive die to the shape depicted in FIGS. 2-4. The inner metal layer 170 may be trimmed either before, after, or during stamping.

In the embodiment illustrated, the outer layer 172 is formed separately then layered with the insulation layer 174 and inner metal layer 170. An injection molding process or other plastic forming process may be used to form outer layer 172 with a desired thickness. The desired thickness of the outer layer may be determined by a desired structural stiffness, desired resonate frequency ranges, and/or resistance to buckling at operating temperatures.

Also in the embodiment illustrated, the inner metal layer 170 will be relatively and slightly oversized compared to the outer layer 172, so that the peripheral edge 188 of the inner metal layer 170 may be folded over, or crimped onto, the outer edge 198 to at least partially enclose outer edge 198 of the outer layer 172. This crimping effectively retains the insulation layer 174 between the layers 170, 172. While layers 170, 172 are described as being coupled by crimping, other coupling devices and methods may be utilized to produce a heat shield 130.

It is to be understood that the above description is intended to be illustrative and not limiting. Many embodiments will be apparent to those of skill in the art upon reading the above description. Therefore, the scope of the invention should be determined, not with reference to the above description, but instead with reference to the appended claims, along with the full scope of equivalents to which such claims are entitled.

What is claimed is:

1. A heat shield for an automotive engine component comprising:
a sheet metal layer selectively facing a heat source;
a plastic layer coupled said sheet metal layer; and
an insulation layer at least partially interposed between said sheet metal layer and said plastic layer.

2. The heat shield of claim 1, wherein a peripheral edge of said metal layer at least partially overlays an edge of said plastic layer.

3. The heat shield of claim 1, wherein said component comprises an exhaust manifold fixed to engine, adapted to carry hot engine gases away from said engine.

4. The heat shield of claim 1, wherein said inner layer and said outer layer have generally the same contour and wherein said inner layer and said outer layer selectively nest thereby confining said insulation layer.

5. The heat shield of claim 1, wherein said metal layer is greater than about 0.010 inch in thickness.

6. The heat shield of claim 1, wherein said metal layer provides structural rigidity for the heat shield.

7. The heat shield of claim 1, wherein said insulation layer includes aramid fibers.

8. A heat shield for an under-the-hood vehicular engine component comprising:
an outer plastic layer having a first outer surface, a second outer surface, and an outer edge;
an inner metal layer defined, at least in part, by a first inner surface, a second inner surface, and a peripheral edge, wherein said inner metal layer is selectively positioned directly proximal to a shielded component, and wherein at least portions of said first outer surface and said second inner surface define a gap therebetween.

9. The heat shield of claim 8, wherein said peripheral edge is at least partially crimped onto said outer edge.

10. The heat shield of claim 8, further comprising an insulation layer interposed at least partially between said metal layer and said plastic layer.

11. The heat shield of claim 8 wherein said inner metal layer directly adjacent said shielded component selectively reflects heat from the shielded component away from the heat shield.

12. The heat shield of claim 8, wherein said metal layer is greater than about 0.010 inch in thickness.

13. The heat shield of claim 8, wherein said component comprises an exhaust manifold fixed to an engine.

14. A method of manufacturing a heat shield comprising the steps of:
forming an outer plastic layer;
forming an inner metallic layer; and
positioning said outer layer adjacent said inner layer.

15. The method of claim 14, further comprising the step of positioning at least partially an insulation layer adjacent the inner metallic layer.

16. The method of claim 15, wherein said step of positioning is performed after said steps of forming.

17. The method of claim 14, further comprising the step of crimping a peripheral edge of the inner metallic layer at least partially adjacent an outer edge of the outer plastic layer.

18. The method of claim 14, wherein said step of positioning is performed after said steps of forming.

19. The method of claim 14, wherein the step forming said inner metallic layer includes using a progressive die.

20. The method of claim 14, further comprising the step of coupling the inner metallic layer at least partially to the outer plastic layer.
